(19) United States
(12) Patent Application Publication
(10) Pub. No.: US 2025/0113212 A1
(43) Pub. Date: Apr. 3, 2025

(54) WIRELESS COMMUNICATION APPARATUS, SCHEDULING METHOD, AND NON-TRANSITORY COMPUTER-READABLE MEDIUM

(71) Applicant: NEC Corporation, Minato-ku, Tokyo (JP)

(72) Inventors: Jun Shikida, Tokyo (JP); Kazushi Muraoka, Tokyo (JP)

(73) Assignee: NEC Corporation, Minato-ku, Tokyo (JP)

(21) Appl. No.: 18/833,009

(22) PCT Filed: Mar. 8, 2022
(86) PCT No.: PCT/JP2022/010018

§ 371 Date: Jul. 25, 2024

(51) Int. Cl. H04W 16/28; H04B 17/309; H04B 17/318

(52) U.S. Cl. CPC H04W 16/28; H04B 17/328; H04B 17/346

(57) ABSTRACT

An object of the present disclosure is to provide a wireless communication apparatus, a wireless communication system, a scheduling method, and a non-transitory computer-readable medium which are capable of reducing an amount of calculation for selecting a combination of wireless devices to be spatially multiplexed while suppressing degradation of communication quality. A wireless communication apparatus according to the present disclosure includes: an acquisition unit that acquires measurement results of reception quality of a plurality of beams received by a plurality of wireless devices from each of the plurality of wireless devices; a calculation unit that calculates degrees of similarity in the reception quality between the plurality of wireless devices based on the measurement results; and a selection unit that selects a combination of wireless devices to be spatially multiplexed from among the plurality of wireless devices based on the degrees of similarity.

### TECHNICAL FIELD

The present disclosure relates to a wireless communication apparatus, a wireless communication system, a scheduling method, and a non-transitory computer-readable medium.

### BACKGROUND ART

In fifth generation mobile communication systems (5G) and wireless local area networks (LAN), multi-user multiple input multiple output (MIMO) transmission is used to implement high-speed communication. The multi-user MIMO transmission is a communication scheme in which signals of a plurality of terminals are spatially multiplexed at the same time and at the same frequency. The performance of the multi-user MIMO transmission depends on a spatial correlation of channels between wireless devices to be multiplexed. In a case where the multi-user MIMO transmission is applied to a combination of wireless devices having a higher spatial correlation of channels, communication quality is deteriorated due to an influence of interference between the wireless devices. Patent Literature 1 and Patent Literature 2 disclose wireless communication methods to which the multi-user MIMO transmission is applied.

Patent Literature 2 discloses a method of selecting a wireless device to which multi-user MIMO transmission is applied. The method described in Patent Literature 2 discloses a method of calculating right singular vectors of a channel matrix for each of wireless devices and selecting a combination of terminals having a smaller inner product of the right singular vectors as the wireless device to which the multi-user MIMO transmission is applied. Patent Literature 2 discloses that a combination of wireless devices having a lower spatial correlation of channels can be selected by the selection method, so that communication quality in applying the multi-user MIMO transmission can be improved.

### CITATION LIST

### Patent Literature

Patent Literature 1: Japanese Unexamined Patent Application Publication No. 2007-214995
Patent Literature 2: Japanese Unexamined Patent Application Publication No. 2008-98940

### SUMMARY OF INVENTION

### Technical Problem

The method described in Patent Literature 2 requires a large amount of calculation for calculating the right singular vectors of the channel matrixes. Further, since an element of the right singular vector is a complex number, a large amount of calculation is also required for calculating the inner product of the right singular vectors. In particular, when the number of wireless devices or the number of antennas of the base station is large, a large amount of calculation is required.

An object of the present disclosure is to provide a wireless communication apparatus, a wireless communication system, a scheduling method, and a non-transitory computer-readable medium which are capable of reducing an amount of calculation for selecting a combination of wireless devices to be spatially multiplexed while suppressing degradation of communication quality.

### Solution to Problem

A wireless communication apparatus according to the present disclosure includes:
an acquisition unit that acquires measurement results of reception quality of a plurality of beams received by a plurality of wireless devices from each of the plurality of wireless devices;
a calculation unit that calculates degrees of similarity in the reception quality between the plurality of wireless devices based on the measurement results; and
a selection unit that selects a combination of wireless devices to be spatially multiplexed from among the plurality of wireless devices based on the degrees of similarity.

A wireless communication system according to the present disclosure includes:
a plurality of wireless devices; and
a wireless communication apparatus that communicates with the plurality of wireless devices,
the wireless communication apparatus including:
an acquisition unit that acquires measurement results of reception quality of a plurality of beams received by the plurality of wireless devices from each of the plurality of wireless devices;
a calculation unit that calculates degrees of similarity in the reception quality between the plurality of wireless devices based on the measurement results; and
a selection unit that selects a combination of wireless devices to be spatially multiplexed from among the plurality of wireless devices based on the degrees of similarity,
the wireless device including:
a measurement unit that measures the reception quality of the plurality of beams; and
a terminal transmission unit that transmits the measurement results to the wireless communication apparatus.

A scheduling method according to the present disclosure includes:
acquiring measurement results of reception quality of a plurality of beams received by a plurality of wireless devices from each of the plurality of wireless devices;
calculating degrees of similarity in the reception quality between the plurality of wireless devices based on the measurement results; and
selecting a combination of wireless devices to be spatially multiplexed from among the plurality of wireless devices based on the degrees of similarity.

A non-transitory computer-readable medium according to the present disclosure stores a scheduling program for causing a computer to execute:
acquiring measurement results of reception quality of a plurality of beams received by a plurality of wireless devices from each of the plurality of wireless devices:
calculating degrees of similarity in the reception quality between the plurality of wireless devices based on the measurement results; and
selecting a combination of wireless devices to be spatially multiplexed from among the plurality of wireless devices based on the degrees of similarity.

### Advantageous Effects of Invention

According to the present disclosure, it is possible to provide the wireless communication apparatus, the wireless communication system, the scheduling method, and the non-transitory computer-readable medium which are capable of reducing the amount of calculation for selecting the combination of wireless devices to be spatially multiplexed while suppressing the degradation of the communication quality.

### BRIEF DESCRIPTION OF DRAWINGS

FIG. 1 is a block diagram illustrating a wireless communication apparatus according to a first example embodiment.

FIG. 2 is a flowchart illustrating an operation of the wireless communication apparatus according to the first example embodiment:

FIG. 3 is a block diagram illustrating a wireless communication system according to a second example embodiment.

FIG. 4 is a block diagram illustrating a wireless communication apparatus according to the second example embodiment.

FIG. 5 is a block diagram illustrating a scheduling unit according to the second example embodiment.

FIG. 6 is a flowchart illustrating an operation of the wireless communication apparatus according to the second example embodiment.

FIG. 7 is a block diagram illustrating a hardware configuration of a computer (information processing apparatus) capable of achieving the wireless communication apparatus and the like according to each of the example embodiments of the present disclosure.

### EXAMPLE EMBODIMENT

Hereinafter, example embodiments of the present invention will be described with reference to the drawings. In the drawings, the same or corresponding elements are denoted by the same reference signs and redundant description will be omitted if necessary for clarity of description.

### First Example Embodiment

### <Overview of Configuration of Wireless Communication Apparatus>

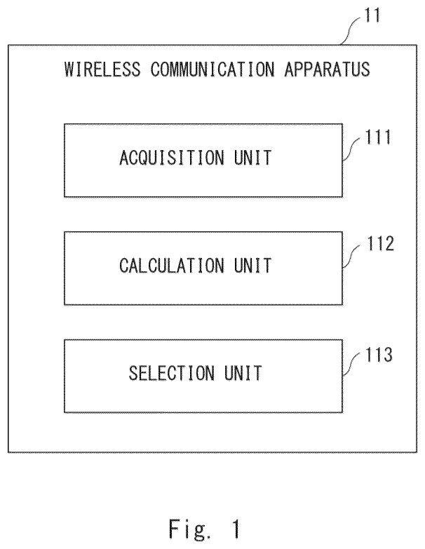

FIG. 1 is a block diagram illustrating a wireless communication apparatus according to a first example embodiment.

FIG. 1 illustrates a minimum configuration of the wireless communication apparatus according to the first example embodiment.

As illustrated in FIG. 1, the wireless communication apparatus 11 according to the first example embodiment performs wireless communication with a plurality of wireless devices (not illustrated). The wireless communication apparatus 11 includes an acquisition unit 111, a calculation unit 112, and a selection unit 113.

The acquisition unit 111 acquires, from each of the plurality of wireless devices, measurement results of reception quality of a plurality of beams received by the plurality of wireless devices.

The calculation unit 112 calculates degrees of similarity in the reception quality between the plurality of wireless devices based on the measurement results acquired by the acquisition unit 111.

The selection unit 113 selects a combination of wireless devices to be spatially multiplexed from the plurality of wireless devices based on the degrees of similarity in the reception quality calculated by the calculation unit 112.

### <Outline of Operation of Wireless Communication Apparatus>

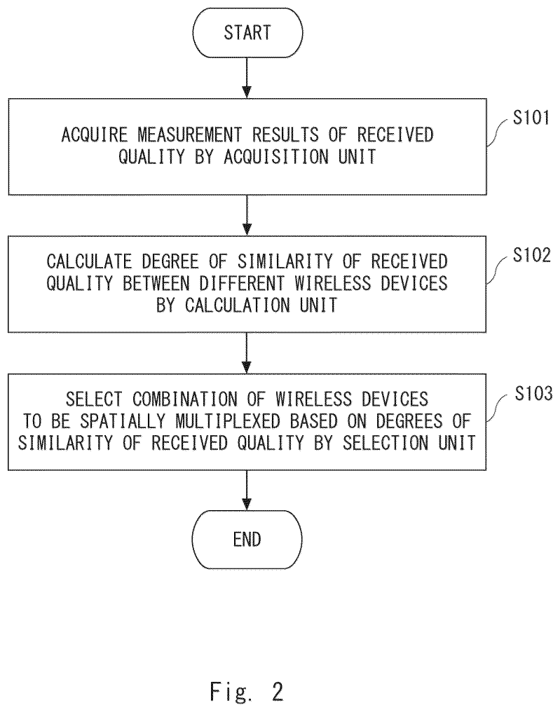

FIG. 2 is a flowchart illustrating an operation of the wireless communication apparatus according to the first example embodiment.

FIG. 2 illustrates an operation in a case where the minimum configuration of the wireless communication apparatus according to the first example embodiment is used.

As illustrated in FIG. 2, the acquisition unit 111 acquires measurement results of reception quality of a plurality of beams transmitted from the wireless communication apparatus 11 and received by a plurality of wireless devices (step S101).

The calculation unit 112 calculates degrees of similarity in the reception quality between the plurality of wireless devices based on the measurement results acquired by the acquisition unit 111. That is, the calculation unit 112 calculates the degree of similarity in the reception quality between different wireless devices (step S102).

The selection unit 113 selects a combination of wireless devices to be spatially multiplexed from the plurality of wireless devices based on the degrees of similarity in the reception quality calculated by the calculation unit 112 (step S103).

As described above, the wireless communication apparatus 11 acquires the measurement results of the reception quality of the plurality of beams received by the plurality of wireless devices from each of the plurality of wireless devices, calculates the degrees of similarity in the reception quality between the plurality of wireless devices based on the measurement results of the reception quality, and selects the combination of wireless devices to be spatially multiplexed based on the degrees of similarity in the reception quality.

The wireless communication apparatus 11 estimates a spatial correlation of channels between the wireless devices based on the degree of similarity in the reception quality of the plurality of beams. Since the reception quality of the plurality of beams is a real value, the wireless communication apparatus 11 can calculate the degree of similarity in the reception quality with a small amount of calculation. Therefore, the wireless communication apparatus 11 can reduce the amount of calculation required to select a wireless device to which multi-user MIMO transmission is applied while suppressing deterioration of communication quality.

As a result, the wireless communication apparatus 11 can reduce the amount of calculation for selecting a combination of wireless devices to be spatially multiplexed while suppressing degradation of the communication quality.

### Second Example Embodiment

### <Configuration of Wireless Communication System>

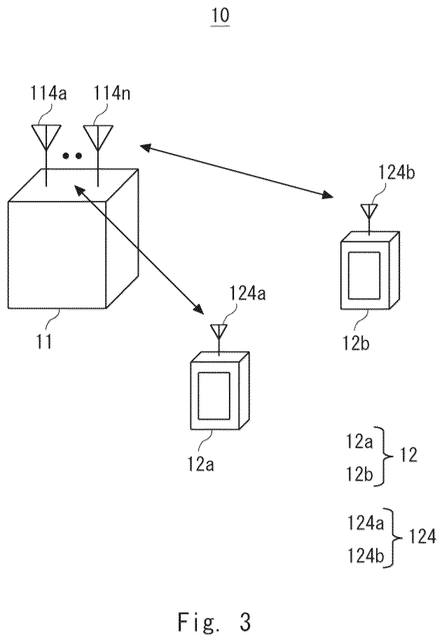

FIG. 3 is a block diagram illustrating a wireless communication system according to a second example embodiment.

The second example embodiment is obtained by expanding the first example embodiment to a system in more detail. A wireless communication system 10 illustrated in FIG. 3 may be a long term evolution (LTE) system, a fifth generation mobile communication system, a sixth generation mobile communication system, or a wireless LAN system.

As illustrated in FIG. 3, the wireless communication system 10 includes a plurality of wireless devices 12 and the wireless communication apparatus 11 that communicates with the plurality of wireless devices 12. In an example illustrated in FIG. 3, the plurality of wireless devices 12 are illustrated as a wireless device 12a and a wireless device 12b. Note that the wireless communication system 10 is described as including two wireless devices (the wireless device 12a and the wireless device 12b) in FIG. 3, but is not limited thereto. The wireless communication system 10 may include three or more wireless devices 12.

The wireless communication apparatus 11 may be, for example, a base station, an access point, an evolved NodeB (eNode B or eNB), an NR NodeB (NR NB), a gNodeB (gNB), or an ng-eNB.

The wireless communication apparatus 11 includes an antenna 114a to an antenna 114n in addition to the acquisition unit 111 and the calculation unit 112. The wireless communication apparatus 11 is connected to and communicates with the wireless devices 12 via the antenna 114a to the antenna 114n. Note that, in a case where it is not necessary to distinguish the antennas 114a to 114n from each other, they are simply referred to as “antennas 114” in the following description.

The wireless device 12 may be, for example, a mobile station, user equipment (UE), or a relay apparatus having a relay function.

The wireless device 12 includes a measurement unit (not illustrated) that measures reception quality of a plurality of beams transmitted from the wireless communication apparatus 11, and a terminal transmission unit (not illustrated) that transmits measurement results to the wireless communication apparatus 11. The wireless device 12 includes an antenna 124 in addition to the measurement unit and the terminal transmission unit (the wireless device 12a includes an antenna 124a, and the wireless device 12b includes an antenna 124b). The wireless device 12 is connected to and communicates with the wireless communication apparatus 11 via the antenna 124.

Note that the wireless device 12 is described as including one antenna in FIG. 3, but is not limited thereto. The wireless device 12 may include two or more antennas. Furthermore, in a case where it is not necessary to distinguish the wireless device 12a and the wireless device 12b from each other, they are simply referred to as the “wireless devices 12” in the following description. Furthermore, in a case where it is not necessary to distinguish the antenna 124a and the antenna 124b from each other, they are simply referred to as the “antennas 124” in the following description.

### <Configuration of Wireless Communication Apparatus>

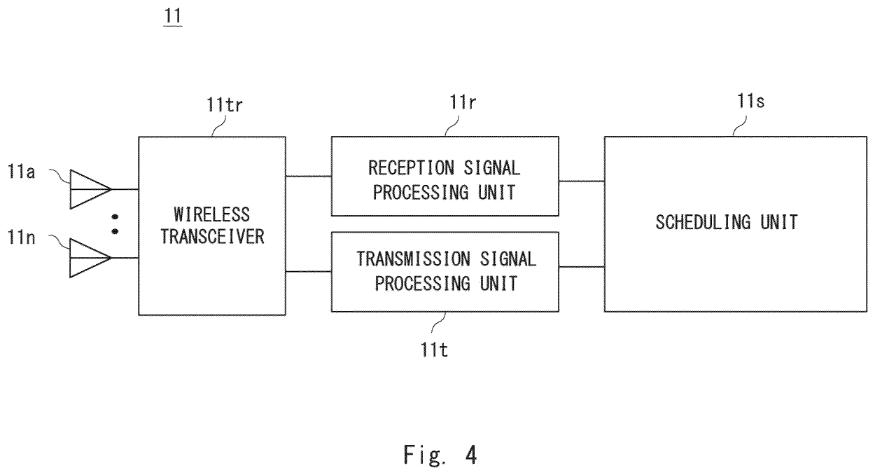

FIG. 4 is a block diagram illustrating the wireless communication apparatus according to the second example embodiment.

In FIG. 4, the wireless communication apparatus 11 includes antennas 11a to 11n, a wireless transceiver 11tr, a reception signal processing unit 11r, a scheduling unit 11s, and a transmission signal processing unit 11t. Note that parts not directly related to the second example embodiment are not illustrated in FIG. 4.

The antenna 11a to the antenna 11n receive a radio signal transmitted from the wireless device 12 and output the received radio signal to the wireless transceiver 11tr. Furthermore, the antennas 11a to 11n transmit a radio signal input from the wireless transceiver 11tr to the wireless device 12.

The wireless transceiver 11tr converts the radio signal input to the antenna 11a to the antenna 11n into a baseband signal and outputs the baseband signal to the reception signal processing unit 11r. Furthermore, the wireless transceiver 11tr converts a baseband signal input from the transmission signal processing unit 11t into a radio signal and outputs the radio signal to the antenna 11a to the antenna 11n.

The reception signal processing unit 11r demodulates and decodes the baseband signal input from the wireless transceiver 11tr. The reception signal processing unit 11r receives a data signal and a control signal transmitted from the wireless device 12 via the antenna 11a to the antenna 11n and the wireless transceiver 11tr. The reception signal processing unit 11r outputs the received measurement result of the reception quality in the wireless device 12 and the like to the scheduling unit 11s.

The scheduling unit 11s allocates a radio resource to the wireless device 12 using the measurement result of the reception quality in the wireless device 12 input from the reception signal processing unit 11r and the like, and outputs an allocation result to the transmission signal processing unit 11t. Note that, in a case where the scheduling unit 11s allocates a radio resource for transmitting a data signal from the wireless device 12, an allocation result of the radio resource is also output to the reception signal processing unit 11r such that the data signal from the wireless device 12 can be received.

The transmission signal processing unit 11t generates a baseband signal for notifying the wireless device 12 of the allocation of the radio resource based on the allocation result of the radio resource input from the scheduling unit 11s. In a case where the scheduling unit 11s allocates a radio resource for transmitting a data signal from the wireless communication apparatus 11 to the wireless device 12, a baseband signal including the data signal is generated. The transmission signal processing unit 11t outputs the generated baseband signal to the wireless transceiver 11tr.

### <Configuration of Scheduling Unit>

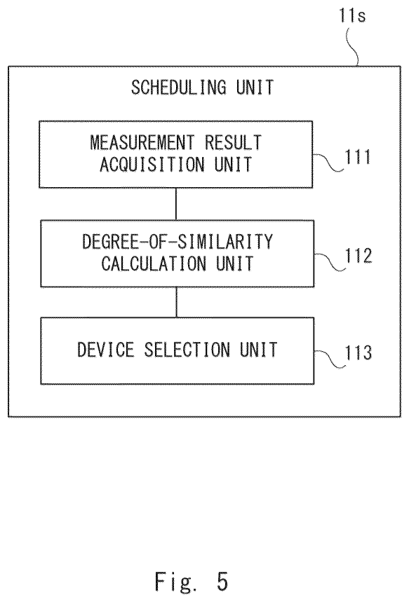

FIG. 5 is a block diagram illustrating the scheduling unit according to the second example embodiment.

As illustrated in FIG. 5, the scheduling unit 11s includes a measurement result acquisition unit 111, a degree-of-similarity calculation unit 112, and a device selection unit 113. Note that parts not directly related to the second example embodiment are not illustrated in FIG. 5. The measurement result acquisition unit corresponds to the acquisition unit illustrated in FIG. 1, the degree-of-similarity calculation unit corresponds to the calculation unit illustrated in FIG. 1, and the device selection unit corresponds to the selection unit illustrated in FIG. 1.

The wireless communication apparatus 11 further includes a transmission unit (corresponding to a transmitting part of the wireless transceiver illustrated in FIG. 4) that transmits a reference signal to the plurality of wireless devices 12 using the plurality of beams.

The measurement result acquisition unit 111 acquires the measurement result of the reception quality in the wireless device 12 from the reception signal processing unit 11r, and outputs the acquired measurement result of the reception quality to the degree-of-similarity calculation unit 112. The measurement result acquisition unit 111 acquires reception quality of the reference signal as the reception quality.

The reception quality in the wireless device 12 only needs to be measured based on, for example, the reference signal transmitted from the wireless communication apparatus 11. The reference signal may be, for example, a reference signal periodically transmitted from the wireless communication apparatus 11 for monitoring the wireless line quality. The reference signal may be, for example, a cell-specific reference signal (CRS), a channel state information-reference signal (CSI-RS), or a physical broadcast channel-demodulation reference signal (PBCH-DMRS) of NR.

The wireless communication apparatus 11 transmits the reference signal using a plurality of beams having different radiation directions. The wireless device 12 measures the reception quality of the reference signal for each of the beams and reports the measurement result to the wireless communication apparatus 11. The measurement result of the reception quality may be, for example, a measurement result of the reception quality periodically measured and reported by the wireless device 12 for monitoring the wireless line quality.

The measurement result of the reception quality may be, for example, at least any one of Reference Signal Received Power (RSRP), Reference Signal Received Quality (RSRQ), and a Signal to Interference plus Noise Ratio (SINR). When the acquired reception quality of the beam is a relative value, the measurement result acquisition unit 111 may convert the relative value into an absolute value. Furthermore, when the acquired reception quality of the beam is a decibel value, the measurement result acquisition unit 111 may convert the reception quality into a linear value.

The degree-of-similarity calculation unit 112 calculates a degree of similarity in the reception quality between different wireless devices 12 using the measurement results of the reception quality input from the measurement result acquisition unit 111, that is, calculates the degree of similarity in the reception quality between the plurality of wireless devices 12 based on the measurement results, and outputs the calculated degree of similarity in the reception quality to the device selection unit 113.

Here, calculation examples of the degree of similarity of (the measurement result of) the reception quality calculated by the degree-of-similarity calculation unit 112 will be described below.

In a first example of the degree of similarity in the reception quality, combinations of a predetermined number of beams with the higher reception quality for the plurality of wireless devices 12, respectively, and the degree of similarity is calculated based on the number of common beams included in the combinations of the predetermined number of beams.

That is, combinations of A beams (A is an integer of one or more) with high reception quality are compared between different wireless devices 12, and the number of common beams included in the combinations of A beams is used as the degree of similarity. In the first example, the degree of similarity is an integer ranging from 0 to A.

For example, a case where A=2, a combination of two beams with high reception quality of an i-th (i is an integer) wireless device 12i is a beam #1 and a beam #2, and a combination of two beams with high reception quality of a j-th (j is an integer) wireless device 12j is a beam #1 and a beam #3 is considered. In this case, a common beam between the wireless device 12i and the wireless device 12j is the beam #1, and thus, the degree of similarity in the reception quality between the wireless device 12i and the wireless device 12j is one.

Note that the maximum value of the degree of similarity may be used to perform normalization such that a value of the degree of similarity is equal to or less than one. For example, when A=2 and the degree of similarity is one, the normalized degree of similarity is (½)=0.5. Here, “/” represents a division. Furthermore, in a case where the number of beams for which measurement results of the reception quality are acquired is limited, a value of A may be set so as to be equal to or less than the number of beams for which the measurement results are acquired.

As described above, according to the first example, the degree of similarity can be obtained only by comparing combinations of beams with high reception quality between different wireless devices 12, and thus, the degree of similarity can be obtained with a small amount of calculation. Furthermore, since the combinations of beams with high reception quality are compared according to the first example, it is also possible to suppress the degradation of the communication quality.

In a second example of the degree of similarity in the reception quality, a reception quality vector having the reception quality of each of the plurality of beams as an element is calculated for each of the plurality of wireless devices 12, and the degree of similarity is calculated based on an inner product of the reception quality vectors. That is, each of the wireless devices 12 generates the reception quality vector having the reception quality of each of the beams as the element. Here, it is assumed that the number of beams is B, and reception quality of a b-th (b is an integer of one or more and B or less) beam in the i-th wireless device 12i is r_{i,b}. At this time, a reception quality vector rᵢ of the i-th wireless device 12i can be expressed as Formula (1).

$${Γ}_{i}^{T} = ( {r}_{i , 1} {r}_{i , 2} … {r}_{i , B} ) \qquad ( 1 )$$

Here, T represents transposition. Note that, in a case where there is a beam of which a measurement result of the reception quality is not acquired, a predetermined value determined in advance or a previously acquired measurement result may be substituted into an element of the reception quality vector corresponding to the beam.

Then, the degree of similarity in the reception quality between different wireless devices 12 is calculated using the reception quality vector rᵢ. For example, a degree of similarity S_{i,j} of the reception quality between the i-th wireless device 12i and the j-th wireless device 12j can be expressed as Formula (2) using the reception quality vector rᵢ and a reception quality vector rⱼ.

$${S}_{i , j} = \frac{{r}_{i}^{T} {r}_{j}}{‖ {r}_{i} ‖ \cdot ‖ {r}_{j} ‖} \qquad ( 2 )$$

Here, ∥a∥ represents the norm of the vector a. As can be understood from Formula (2), the second example corresponds to an inner product of the normalized reception quality vectors rᵢ and rⱼ. Therefore, the reception quality vectors of the respective wireless devices 12 may be normalized in advance before the degree of similarity is calculated. As a result, the degree of similarity is calculated only by the inner product of the vectors, and the amount of calculation can be reduced.

As described above, according to the second example, the degree of similarity can be obtained from an inner product of vectors of real numbers, and thus, the degree of similarity can be obtained with a small amount of calculation. Furthermore, since a value of the reception quality of each beam is taken into consideration, the degree of similarity in the reception quality can be obtained with higher accuracy as compared with the first example.

The device selection unit 113 selects a combination of the wireless devices 12 to be spatially multiplexed by using the degree of similarity in the reception quality between the different wireless devices 12 input from the degree-of-similarity calculation unit 112, and outputs a selection result to the transmission signal processing unit 11t. Note that, in a case where the device selection unit 113 selects a combination of the wireless devices 12 to be spatially multiplexed at the time of transmitting data signals from the wireless devices 12, a selection result of the combination of the wireless devices 12 to be spatially multiplexed is also output to the reception signal processing unit 11r such that the data signals from the wireless devices 12 can be received.

A first selection method for the wireless devices 12 to be spatially multiplexed is, for example, a method of comparing the degree of similarity in the reception quality with a preset first threshold and selecting the wireless devices 12 such that a pair of the wireless devices 12 having the degree of similarity in the reception quality equal to or more than the first threshold is not included in combinations of the wireless devices 12 to be spatially multiplexed. That is, the first selection method is a method of selecting a combination of the wireless devices 12 to be spatially multiplexed such that the degrees of similarity between the plurality of the wireless devices 12 included in the combination of the wireless devices 12 to be spatially multiplexed are less than the first threshold.

A second selection method for the wireless devices 12 to be spatially multiplexed is a method of selecting a combination of the wireless devices 12 to be spatially multiplexed such that a sum of the degrees of similarity between the plurality of wireless devices 12 included in the combination of the wireless devices 12 to be spatially multiplexed is less than a second threshold.

A third selection method for the wireless devices 12 to be spatially multiplexed is a method of calculating a sum of the degrees of similarity in the reception quality of an already-selected wireless device 12 with respect to each of unselected wireless devices 12 and not selecting the wireless device 12 for which the calculated sum of the degrees of similarity in the reception quality is equal to or more than a third threshold. That is, the third selection method is a method of calculating the sum of the degrees of similarity in the reception quality of the already-selected wireless device 12 with respect to each of the unselected wireless devices 12 and selecting the wireless device 12 for which the calculated sum of the degrees of similarity in the reception quality is less than the third threshold.

The third selection method may be a method of calculating the sum of the degrees of similarity in the reception quality of the already-selected wireless device 12 with respect to each of the unselected wireless devices 12 and preferentially selecting the wireless device 12 with a smaller calculated sum of the degrees of similarity in the reception quality. Note that the already selected wireless device 12 may be, for example, the wireless device 12 selected by the first selection method or the second selection method. Alternatively, the unselected wireless device 12 may be, for example, the wireless device 12 that is not selected by the first selection method or the second selection method.

### <Operation of Wireless Communication Apparatus>

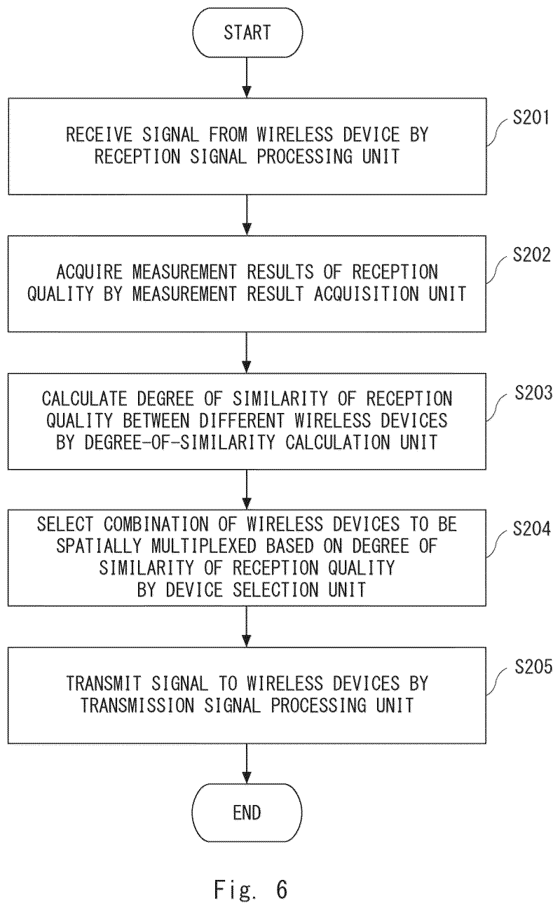

FIG. 6 is a flowchart illustrating an operation of the wireless communication apparatus according to the second example embodiment.

As illustrated in FIG. 6, the reception signal processing unit 11r receives a data signal and a control signal transmitted from the wireless device 12 (step S201).

The measurement result acquisition unit 111 acquires measurement results of reception quality of a plurality of beams received by the wireless devices 12 (step S202).

The degree-of-similarity calculation unit 112 calculates a degree of similarity in the reception quality between different wireless devices 12 (between each pair of the plurality of wireless devices 12) based on the measurement results of the reception quality (step S203).

The device selection unit 113 selects a combination of wireless devices 12 to be spatially multiplexed based on the degrees of similarity in the reception quality (step S204).

The transmission signal processing unit 11t transmits radio resource allocation information and a data signal to the wireless devices 12 based on a selection result of the combination of the wireless devices 12 to be spatially multiplexed (step S205).

As described above, the reception signal processing unit 11r receives the data signal and the control signal transmitted from the wireless device 12. The measurement result acquisition unit 111 acquires the measurement results of the reception quality of the plurality of beams received by each of the wireless devices 12. The degree-of-similarity calculation unit 112 calculates the degree of similarity in the reception quality between the different wireless devices 12 based on the measurement results of the reception quality. The device selection unit 113 selects the combination of the wireless devices 12 to be spatially multiplexed based on the degrees of similarity in the reception quality. The transmission signal processing unit 11t transmits the radio resource allocation information and the data signal to the wireless devices 12 based on the selection result of the combination of the wireless devices 12 to be spatially multiplexed.

The device selection unit 113 according to the second example embodiment estimates a spatial correlation of channels between the wireless devices 12 using (based on) the degree of similarity in the reception quality of the plurality of beams. Since the reception quality of the plurality of beams is a real value, the degree-of-similarity calculation unit 112 can calculate the degree of similarity in the reception quality with a small amount of calculation. Therefore, the wireless communication apparatus 11 according to the second example embodiment enables a reduction of the amount of calculation required to select the wireless device 12 to which the multi-user MIMO transmission is applied while suppressing the deterioration of the communication quality.

### Another Example Embodiment

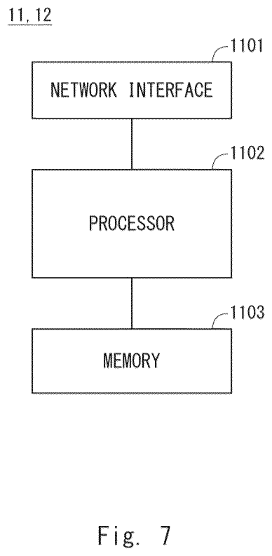

The wireless communication apparatus 11 and the wireless device 12 (hereinafter, referred to as the wireless communication apparatus 11 or the like) according to the above-described example embodiments may have the following hardware configuration. FIG. 7 is a block diagram illustrating a hardware configuration of a computer (information processing apparatus) capable of achieving the wireless communication apparatus and the like according to each of the example embodiments of the present disclosure.

Referring to FIG. 7, the wireless communication apparatus 11 or the like includes a network interface 1101, a processor 1102, and a memory 1103. The network interface 1101 is used to communicate with other communication apparatuses included in the wireless communication system 10.

The processor 1102 reads and executes software (computer program) from the memory 1103 to execute processing in the wireless communication apparatus 11 or the like described with reference to the flowcharts in the above-described example embodiments. The processor 1102 may be, for example, a microprocessor, a micro processing unit (MPU), or a central processing unit (CPU). The processor 1102 may include a plurality of processors.

The memory 1103 is configured by a combination of a volatile memory and a non-volatile memory. The memory 1103 may include a storage disposed away from the processor 1102. In this case, the processor 1102 may access the memory 1103 through an input/output (I/O) interface (not illustrated).

In the example in FIG. 7, the memory 1103 is used to store a group of software modules. The processor 1102 can implement the operation of the wireless communication apparatus 11 or the like described in the above-described example embodiments by reading the group of software modules from the memory 1103 and executing processing according to an instruction by the group of software modules.

As described with reference to FIG. 7, each of the processors included in the wireless communication apparatus 11 or the like executes one or more programs including a group of commends for causing a computer to perform the algorithm described with reference to the drawings.

In the above-described example, the program includes a group of commands (or software code) for causing a computer to perform one or more functions described in the example embodiments when being read by the computer. The program may be stored in a non-transitory computer-readable medium or a tangible storage medium. As an example and not by way of limitation, the computer-readable medium or the tangible storage medium includes a random-access memory (RAM), a read-only memory (ROM), a flash memory, a solid-state drive (SSD) or any other memory technology, a CD-ROM, a digital versatile disc (DVD), a Blu-ray (registered trademark) disc or any other optical disk storage, a magnetic cassette, a magnetic tape, a magnetic disk storage, and any other magnetic storage devices. The program may be transmitted on a transitory computer-readable medium or a communication medium. As an example and not by way of limitation, the transitory computer-readable medium or the communication medium includes propagated signals in electrical, optical, acoustic, or any other form.

In the present specification, user equipment (UE) (or including a mobile station, a mobile terminal, a mobile device, a wireless device, or the like) is an entity connected to a network via a wireless interface.

The present specification is not limited to a dedicated communication apparatus, and can be applied to any device having the following communication function.

Each of the terms “user equipment (UE) (as a word used in 3GPP)”, “mobile station”, “mobile terminal”, “mobile device”, and “wireless device” is intended to be generally synonymous with each other and may be a stand-alone mobile station such as a terminal, a mobile phone, a smartphone, a tablet, a cellular IoT terminal, an IoT device, or the like. It will be understood that the terms “mobile station”, “mobile terminal”, “mobile device” also encompass apparatuses that have been provided for a long period of time.

Furthermore, the UE may be, for example, an item of a production facility, a manufacturing facility, and/or an energy-related machine (as an example, a boiler, an engine, a turbine, a solar panel, a wind power generator, a hydraulic power generator, a thermal power generator, a nuclear power generator, a storage battery, a nuclear power system, a nuclear power-related device, a heavy electrical device, pumps including a vacuum pump and the like, a compressor, a fan, a blower, a hydraulic device, a pneumatic device, a metal processing machine, a manipulator, a robot, a robot application system, a tool, a metal mold, a roll, a conveyance apparatus, a lifting apparatus, a cargo handling apparatus, a textile machine, a sewing machine, a printing machine, a print-related machine, a paper processing machine, a chemical machine, a mining machine, a mine-related machine, a construction machine, a construction-related machine, an agricultural machine and/or instrument, a forestry machine and/or instrument, a fishery machine and/or instrument, a safety and/or environmental protection instrument, a tractor, a bearing, a precision bearing, a chain, a gear, a power transmission apparatus, a lubricating apparatus, a valve, a pipe coupling, and/or an application system of any of the above-described device or machine, or the like). Note that “A and/or B” represents “both A and B or one of A and B”.

Furthermore, the UE may be, for example, an item of a transport apparatus (as an example, a vehicle, an automobile, a two-wheeled automobile, a bicycle, a train, a bus, a handcart, a human-powered vehicle, a ship and other watercraft, an airplane, a rocket, a satellite, a drone, a balloon, or the like).

Furthermore, the UE may be, for example, an item of an information communication apparatus (as an example, an electronic computer and related apparatuses, a communication apparatus and related apparatuses, an electronic component, or the like).

Furthermore, the UE may be, for example, a freezer, freezer application product and apparatus, commercial and service devices, a vending machine, an automatic service machine, business machine and apparatus, or consumer electric and electronic machine and instrument (as an example, an audio device, a speaker, a radio, a video device, a television, an oven range, a rice cooker, a coffee maker, a dishwasher, a washing machine, a dryer, an electric fan, ventilating fan and related products, a vacuum cleaner, or the like).

Furthermore, the UE may be, for example, an electronic application system or an electronic application apparatus (as an example, an X-ray apparatus, a particle acceleration apparatus, a radioactive substance application apparatus, a sound wave application apparatus, an electromagnetic application apparatus, a power application apparatus, or the like).

Furthermore, the UE may be, for example, a bulb, a lighting, a meter, an analyzer, a tester and a measuring machine (as an example, a smoke alarm, a human alarm sensor, a motion sensor, a radio tag, or the like), a watch or a clock, physical and chemical machines, an optical machine, a medical device and/or a medical system, a weapon, an item of cutlery, a hand tool, or the like.

Furthermore, the UE may be, for example, a personal digital assistant or an apparatus equipped with a wireless communication function (as an example, an electronic apparatus (for example, a personal computer, an electronic measuring instrument, or the like) configured such that a wireless card, a wireless module, or the like is attached or inserted thereto.

Furthermore, the UE may be, for example, an apparatus or a part thereof that provides the following applications, services, and solutions in the “Internet of Things (IoT)” using wired and wireless communication technologies.

IoT devices (or things) may include appropriate electronics, software, sensors, network connectivity, and the like, which enable these devices to collect and exchange data with each other and with other communication devices.

Furthermore, the IoT device may be an automated device following a software instruction stored in an internal memory.

Furthermore, the IoT device may operate without requiring human supervision or response.

Furthermore, the IoT device may remain as an apparatus provided for a long period of time and/or remain in an inactive state for a long period of time.

Furthermore, the IoT device may also be mounted as a part of a stationary apparatus. The IoT device may be embedded in a non-stationary apparatus (for example, a vehicle or the like) or attached to an animal or a person to be monitored/tracked.

It will be understood that the IoT technology may be implemented on any communication device that can be connected to a communication network that transmits and receives data regardless of control by a human input or a software command stored in a memory.

It will be understood that the IoT device may also be referred to as machine type communication (MTC) device or a machine-to-machine (M2M) communication device.

It will be understood that the UE may support one or more IoT or MTC applications.

Some examples of the MTC applications are listed in the following table (source: 3GPP TS22.368 V13.2.0 (2017-01-13) Annex B, the contents of which are incorporated herein by reference). This list is not exhaustive and is intended to be indicative of MTC applications as examples.

TABLE 1

| Service Range | MTC Application |
|---|---|
| Security | Monitoring System |
| | Backup for Landline |
| | Control of Physical Access (such as Access to Building) |
| | Car/Driver Security |
| Tracking & | Fleet Management |
| Tracing | Order Management |
| | Telematics Insurance (Pay As You Drive (PAYD) |
| | Asset Management |
| | Navigation |
| | Traffic Information |
| | Road Tolling |
| | Road Traffic Optimization/Steering |
| Payment | Point of Sales (POS) |
| | Vending Machines |
| | Gaming Machines |
| Health | Monitoring Vital Signs |
| | Supporting the Aged or Handicapped |
| | Web Access Telemedicine Points |
| | Remote Diagnostics |
| Remote | Sensor |
| Maintenance/ | Lighting |
| Control | Pumps |
| | Valves |
| | Elevator Control |
| | Vending Machine Control |
| | Vehicle Diagnostics |
| Metering | Power |
| | Gas |
| | Water |
| | Heating |
| | Grid Control |
| | Industrial Metering |
| Consumer | Digital Photo Frame |
| Devices | Digital Camera |
| | eBook |

Applications, services, and solutions may be a mobile virtual network operator (MVNO) service/system, an emergency radio communication service/system, a private branch exchange (PBX) service/system, a PHS/digital cordless telecommunications service/system, a point of sale (POS) service/system, an advertise calling service/system, a multimedia broadcast and multicast service (MBMS) service/system, a vehicle to everything (V2X) service/system, a train radio system, a location information-related service/system, a disaster/emergency wireless communication service/system, an Internet of things (IoT) service/system, a community service/system, a video streaming service/system, a femto cell application service/system, a voice over LTE (VOLTE) service/system, a wireless TAG service/system, a charging service/system, a radio on demand service/system, a roaming service/system, a user activity monitoring service/system, a telecommunications carrier/communication NW selection service/system, a functional restriction service/system, a proof of concept (PoC) service/system, a terminal-oriented personal information management service/system, a terminal-oriented display and video service/system, a terminal-oriented non-communication service/system, an ad-hoc NW/delay tolerant networking (DTN) service/system, or the like.

Note that the above-described categories of the UE are merely application examples of the technical ideas and example embodiments described in the present disclosure. A category of the UE is not limited to these examples, and it goes without saying that those skilled in the art can make various modifications.

Note that the present disclosure is not limited to the above example embodiments, and can be appropriately changed without departing from the gist.

Some or all of the above-described example embodiments may be described as in the following Supplementary Notes, but are not limited to the following Supplementary Notes.

### (Supplementary Note 1)

A wireless communication apparatus including:
an acquisition means for acquiring measurement results of reception quality of a plurality of beams received by a plurality of wireless devices from each of the plurality of wireless devices;
a calculation means for calculating degrees of similarity in the reception quality between the plurality of wireless devices based on the measurement results; and
a selection means for selecting a combination of wireless devices to be spatially multiplexed from among the plurality of wireless devices based on the degrees of similarity.

### (Supplementary Note 2)

The wireless communication apparatus according to Supplementary Note 1, further including a transmission means for transmitting a reference signal to the plurality of wireless devices using the plurality of beams,
wherein the acquisition means acquires the reception quality of the reference signal as the reception quality.

### (Supplementary Note 3)

The wireless communication apparatus according to Supplementary Note 2, wherein the reception quality is at least any one of reference signal received power (RSRP), reference signal received quality (RSRQ), and a signal to interference plus noise ratio (SINR).

### (Supplementary Note 4)

The wireless communication apparatus according to any one of Supplementary Notes 1 to 3, wherein
the calculation means extracts combinations of a predetermined number of beams with the higher reception quality for the plurality of wireless devices, respectively, and calculates the degrees of similarity based on the number of common beams included in the combinations of the predetermined number of beams.

### (Supplementary Note 5)

The wireless communication apparatus according to any one of Supplementary Notes 1 to 3, wherein
the calculation means calculates reception quality vectors each having the reception quality of each of the plurality of beams as an element for the plurality of wireless devices, respectively, and calculates the degrees of similarity based on inner products of the reception quality vectors.

### (Supplementary Note 6)

The wireless communication apparatus according to Supplementary Note 5, wherein the calculation means substitutes a predetermined value into an element of the reception quality vector corresponding to a beam of which the reception quality is not acquired.

### (Supplementary Note 7)

The wireless communication apparatus according to any one of Supplementary Notes 1 to 6, wherein the selection means selects the combination of wireless devices to be spatially multiplexed in such a manner that the degrees of similarity between the plurality of wireless devices included in the combination of wireless devices to be spatially multiplexed are less than a first threshold.

### (Supplementary Note 8)

The wireless communication apparatus according to any one of Supplementary Notes 1 to 6, wherein the selection means selects the combination of wireless devices to be spatially multiplexed in such a manner that a sum of the degrees of similarity between the plurality of wireless devices included in the combination of wireless devices to be spatially multiplexed is less than a second threshold.

### (Supplementary Note 9)

A wireless communication system including:
a plurality of wireless devices; and
a wireless communication apparatus that communicates with the plurality of wireless devices,
wherein the wireless communication apparatus includes: an acquisition means for acquiring measurement results of reception quality of a plurality of beams received by the plurality of wireless devices from each of the plurality of wireless devices: a calculation means for calculating degrees of similarity in the reception quality between the plurality of wireless devices based on the measurement results; and a selection means for selecting a combination of wireless devices to be spatially multiplexed from among the plurality of wireless devices based on the degrees of similarity, and
the wireless device includes: a measurement means for measuring the reception quality of the plurality of beams; and a terminal transmission means for transmitting the measurement results to the wireless communication apparatus.

### (Supplementary Note 10)

The wireless communication system according to Supplementary Note 9, further including a transmission means for transmitting a reference signal to the plurality of wireless devices using the plurality of beams,
wherein the acquisition means acquires the reception quality of the reference signal as the reception quality.

### (Supplementary Note 11)

A scheduling method including:
acquiring measurement results of reception quality of a plurality of beams received by a plurality of wireless devices from each of the plurality of wireless devices;
calculating degrees of similarity in the reception quality between the plurality of wireless devices based on the measurement results; and
selecting a combination of wireless devices to be spatially multiplexed from among the plurality of wireless devices based on the degrees of similarity.

### (Supplementary Note 12)

A non-transitory computer-readable medium storing a scheduling program for causing a computer to execute:
acquiring measurement results of reception quality of a plurality of beams received by a plurality of wireless devices from each of the plurality of wireless devices;
calculating degrees of similarity in the reception quality between the plurality of wireless devices based on the measurement results; and
selecting a combination of wireless devices to be spatially multiplexed from among the plurality of wireless devices based on the degrees of similarity.

### REFERENCE SIGNS LIST

10 WIRELESS COMMUNICATION SYSTEM
11 WIRELESS COMMUNICATION APPARATUS
11tr WIRELESS TRANSCEIVER
11t TRANSMISSION SIGNAL PROCESSING UNIT
11r RECEPTION SIGNAL PROCESSING UNIT
11s SCHEDULING UNIT
111 ACQUISITION UNIT, MEASUREMENT RESULT ACQUISITION UNIT
112 CALCULATION UNIT, DEGREE-OF-SIMILARITY CALCULATION UNIT
113 SELECTION UNIT, DEVICE SELECTION UNIT
114, 114a, 114n ANTENNA
12, 12a, 12b wireless device
124, 124a, 124b ANTENNA
1101 NETWORK INTERFACE
1102 PROCESSOR
1103 MEMORY

What is claimed is:

1. A wireless communication apparatus comprising:
at least one memory storing instructions, and
at least one processor configured to execute the instructions to;
acquire measurement results of reception quality of a plurality of beams received by a plurality of wireless devices from each of the plurality of wireless devices;
calculate degrees of similarity in the reception quality between the plurality of wireless devices based on the measurement results; and
select a combination of wireless devices to be spatially multiplexed from among the plurality of wireless devices based on the degrees of similarity.

2. The wireless communication apparatus according to claim 1, wherein the at least one processor configured to execute the instructions to;
transmit a reference signal to the plurality of wireless devices using the plurality of beams; and
acquire the reception quality of the reference signal as the reception quality.

3. The wireless communication apparatus according to claim 2, wherein the reception quality is at least any one of reference signal received power (RSRP), reference signal received quality (RSRQ), and a signal to interference plus noise ratio (SINR).

4. The wireless communication apparatus according to claim 1, wherein the at least one processor configured to execute the instructions to;
extract combinations of a predetermined number of beams with the higher reception quality for the plurality of wireless devices, respectively, and
calculate the degrees of similarity based on the number of common beams included in the combinations of the predetermined number of beams.

5. The wireless communication apparatus according to claim 1, wherein the at least one processor configured to execute the instructions to;
calculate reception quality vectors each having the reception quality of each of the plurality of beams as an element for the plurality of wireless devices, respectively, and
calculate the degrees of similarity based on inner products of the reception quality vectors.

6. The wireless communication apparatus according to claim 5, wherein the at least one processor configured to execute the instructions to;
substitute a predetermined value into an element of the reception quality vector corresponding to a beam of which the reception quality is not acquired.

7. The wireless communication apparatus according to claim 1, wherein the at least one processor configured to execute the instructions to;
select the combination of wireless devices to be spatially multiplexed in such a manner that the degrees of similarity between the plurality of wireless devices included in the combination of wireless devices to be spatially multiplexed are less than a first threshold.

8. The wireless communication apparatus according to claim 1, wherein the at least one processor configured to execute the instructions to;
select the combination of wireless devices to be spatially multiplexed in such a manner that a sum of the degrees of similarity between the plurality of wireless devices included in the combination of wireless devices to be spatially multiplexed is less than a second threshold.

9.-10. (canceled)

11. A scheduling method comprising:
acquiring measurement results of reception quality of a plurality of beams received by a plurality of wireless devices from each of the plurality of wireless devices;
calculating degrees of similarity in the reception quality between the plurality of wireless devices based on the measurement results; and
selecting a combination of wireless devices to be spatially multiplexed from among the plurality of wireless devices based on the degrees of similarity.

12. A non-transitory computer-readable medium storing a scheduling program for causing a computer to execute:
acquiring measurement results of reception quality of a plurality of beams received by a plurality of wireless devices from each of the plurality of wireless devices;
calculating degrees of similarity in the reception quality between the plurality of wireless devices based on the measurement results; and
selecting a combination of wireless devices to be spatially multiplexed from among the plurality of wireless devices based on the degrees of similarity.
